(19) United States
(12) Patent Application Publication
(10) Pub. No.: US 2021/0233165 A1
(43) Pub. Date: Jul. 29, 2021

(54) SYSTEMS AND METHODS FOR DISTRIBUTED LEDGER BASED GLOBAL CREDIT SCORING

(71) Applicant: JPMORGAN CHASE BANK, N.A., New York, NY (US)

(72) Inventor: Amit Kumar GUPTA, Edison, NJ (US)

(21) Appl. No.: 17/153,305

(22) Filed: Jan. 20, 2021

Related U.S. Application Data
(60) Provisional application No. 62/965,512, filed on Jan. 24, 2020.

(51) Int. Cl. G06Q 40/02

(52) U.S. Cl. CPC G06Q 40/025

(57) ABSTRACT

Systems and methods for decentralized and distributed-ledger based global credit scoring are disclosed. In one embodiment, a method for decentralized and distributed-ledger based global credit scoring may include: (1) receiving, at a bank node in a distributed ledger network comprising a plurality of nodes, the bank node comprising a computer processor, customer data and transaction data for a customer transaction; (2) creating, by the bank node, a block comprising the customer data and the transaction data; and (3) submitting, by the bank node, the block to the distributed ledger network. The nodes validate the block and write the block to the distributed ledger.

### RELATED APPLICATIONS

This application claims the benefit of, and priority to, U.S. Provisional Patent Application Ser. No. 62/965,512, filed Jan. 24, 2020, the disclosure of which is hereby incorporated, by reference, in its entirety.

### BACKGROUND OF THE INVENTION

### 1. Field of the Invention

Embodiments generally relate to systems and methods for decentralized and distributed-ledger based global credit scoring.

### 2. Description of the Related Art

The current credit score and credit evaluation system have legacy problems. The system is centralized, expensive, insecure, and at risk for data theft. Indeed, three large companies have stored and centralized the public data. These credit bureaus do not share information with each other on contract basis. Further, not all banks and agencies feed report to all bureaus, which results in different credit scores. The change to credit history or dispute recovery is slow. Banks and agencies have to pay for annual membership to get data and reports. many agencies do not report customer transaction to bureaus to save money. And there is no “global” credit score, and there is a lack of international credit identity and fraud detection.

### SUMMARY OF THE INVENTION

Systems and methods for decentralized and distributed-ledger based global credit scoring are disclosed. In one embodiment, a method for decentralized and distributed-ledger based global credit scoring may include: (1) receiving, at a bank node in a distributed ledger network comprising a plurality of nodes, the bank node comprising a computer processor, customer data and transaction data for a customer transaction; (2) creating, by the bank node, a block comprising the customer data and the transaction data; and (3) submitting, by the bank node, the block to the distributed ledger network. The nodes validate the block and write the block to the distributed ledger.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 is a high-level illustration of a system for decentralized and distributed-ledger based global credit scoring according to an embodiment;

FIG. 2 is a high-level illustration of a system for decentralized and distributed-ledger based global credit scoring is disclosed according to one embodiment according to an embodiment;

FIG. 3A depicts a method for decentralized and distributed-ledger based global credit scoring according to an embodiment;

FIGS. 3B-3L depict an illustrative implementation of the process of FIG. 3A;

FIG. 4 depicts a method for decentralized and distributed-ledger based global credit scoring according to an embodiment;

FIG. 5 depicts an exemplary architecture according to an embodiment;

FIG. 6 depicts an exemplary transaction use case according to an embodiment;

FIG. 7 depicts an exemplary transaction use case according to an embodiment;

FIG. 8 depicts an exemplary illustration of an implementation according to an embodiment;

FIG. 9 depicts a dashboard with AWS privacy architecture according to an embodiment;

FIG. 10 depicts an exemplary user account number and password according to an embodiment;

FIG. 11 depicts an exemplary user account number and password according to an embodiment.

### DETAILED DESCRIPTION OF PREFERRED EMBODIMENTS

Embodiments are directed to systems and methods for systems and methods for decentralized and distributed-ledger based global credit scoring.

Embodiments may provide a credit score system using distributed ledger technology, such as JPMorgan's Quorum blockchain framework. In one embodiment, a private network of financial institutions may form a consortium of information. Each node in the distributed ledger may be a bank, an authorized agency, etc.

In one embodiment, nodes may be hosed on a cloud Backend as a Service (BaaS), such as (Azure, AWS, GAIA, etc.). Banks may upload their customers' credit information in a standard format on regular schedules (similar to what is currently done), in real-time, or as necessary and/or desired. The data is shared to connected nodes (e.g., banks and agencies) over the network in real-time, or substantially in real-time.

The distributed ledger network may use an encrypted data sharing model. For example, all data is encrypted and then passed over network.

Blocks may be created for every transaction, such as when a customer transaction is added, when the report is accessed, etc.

Score calculation may be performed at credit exchange nodes. This may be part of a private network, and the nodes may have a local credit score calculation algorithm. For example, most countries have some credit score exchange; in the United States, FICO is an example of a credit exchange.

Banks may onboard their customers, and the system may generate a unique account number for the customer that is mapped to the customer's national identifier. The account number may be an alphanumeric encrypted private key. For example, in the account number may be mapped to the customer's SSN (USA), PAN (India), NI number (UK).

An example account number is provided in FIG. 15.

Agencies that need to check a credit score may participate as registered nodes in the network (e.g., a bank). A bank or agency may make a request on a distributed application, or “Dapp” (e.g., a web or mobile application) that may execute a smart contract for the credit report. In one embodiment, the customer may be required to approve the request through, for example, registered email, SMS message, an application, etc. Once approved, the request may be routed to the credit exchange that may return the score and summary as requested. In one embodiment, the data that is used is real-time data, or substantially real-time data, and may be shared across all nodes.

In one embodiment, customers may join the distributed ledger network at a public node and have access to the customer's own credit report using, for example, a distributed application.

Embodiments may provide some or all of the following: (1) data may be decentralized and shared across network the distributed ledger network; there is no centralized company or repository; (2) bank involvement in the process and being on a private chain increases data privacy and data accessibility; (3) a global credit score may be provided; (4) cross-border fraud is controlled; (5) increased stability against data disasters because nodes are on the cloud datacenter; (6) the system may boost customer confidence in whole system; (7) embodiments may help with Report of Foreign Bank and Financial Accounts (FBAR) and Foreign Account Tax Compliance Act (FATC).

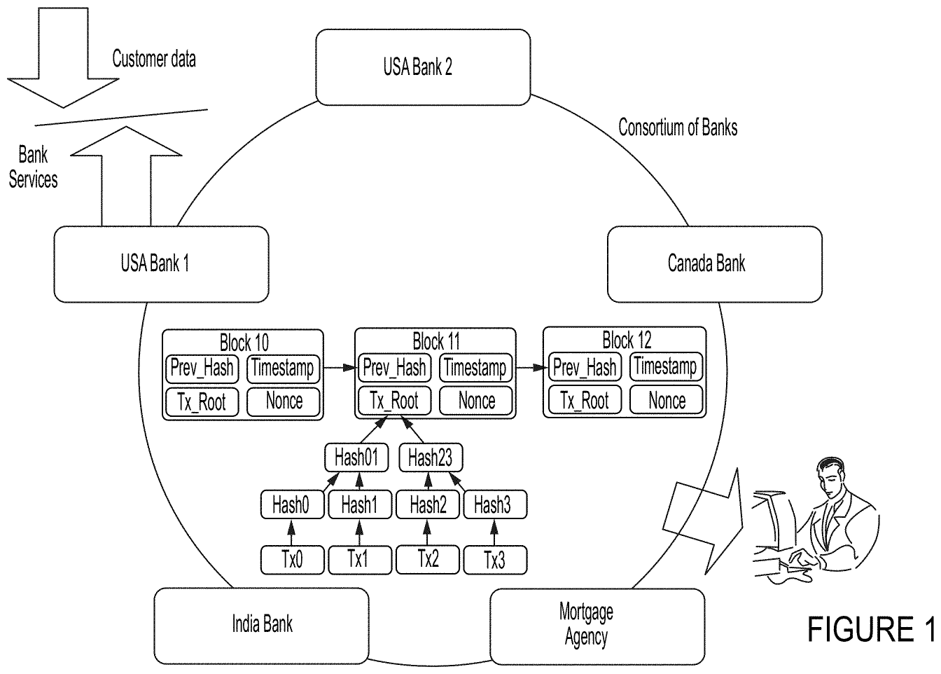

Referring to FIG. 1, a high-level illustration of a system for decentralized and distributed-ledger based global credit scoring is disclosed according to one embodiment. The system may include a plurality of banks (e.g., USA Bank 1, USA Bank 2, India Bank, Canada Bank, etc.) and a lender (e.g., mortgage agency). Each bank may participate as a node in the distributed ledger, and may write customer data to the distributed ledger.

Although only four banks are depicted, it should be recognized that any suitable number of banks, and from any suitable part of the world, may participate as is necessary and/or desired.

In one embodiment, the mortgage agency may also participate as a node in the distributed ledger network.

In one embodiment, the banks may be “full” nodes (e.g., read and write) and may be hosted by a BaaS or by local setup.

An agency may be a full or partial prune node. For example, these nodes may do a fast sync and may not download all blocks (supported in Ethereum).

Public and small nodes may connect to a distributed app (e.g., a web application) to get score on demand from credit exchange (FICO).

In one embodiment, nodes may be connected to p2p, and may or not be privately configured.

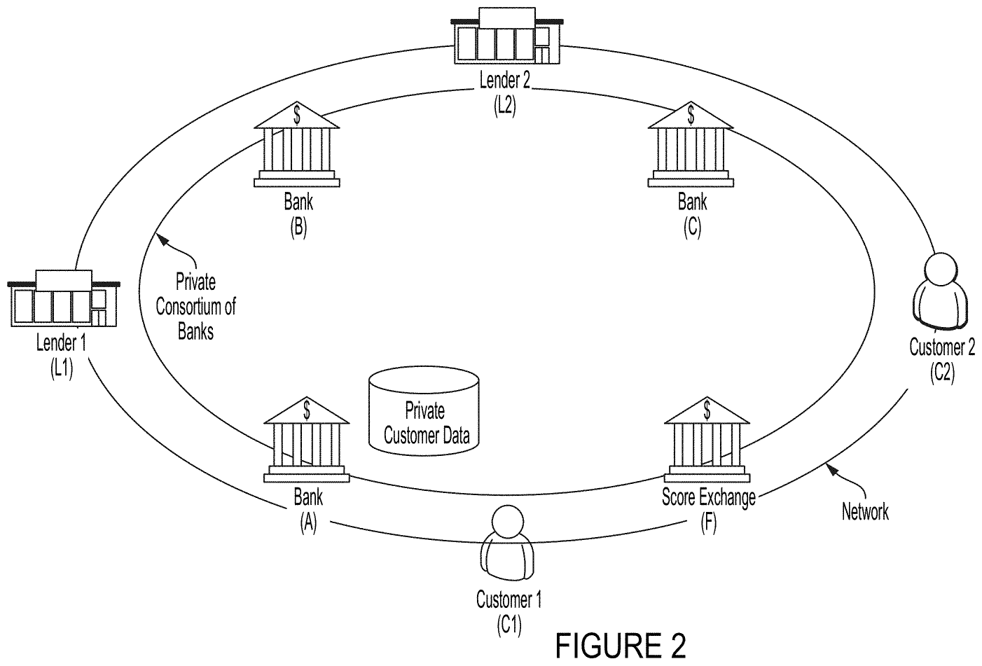

Referring to FIG. 2, a high-level illustration of a system for decentralized and distributed-ledger based global credit scoring is disclosed according to one embodiment. Like FIG. 1, the system depicts a private consortium of banks, as well as a score exchange for calculating a credit score. A second network is illustrated that includes one or more of Lender 1, Lender 2, Customer 1, and Customer 2.

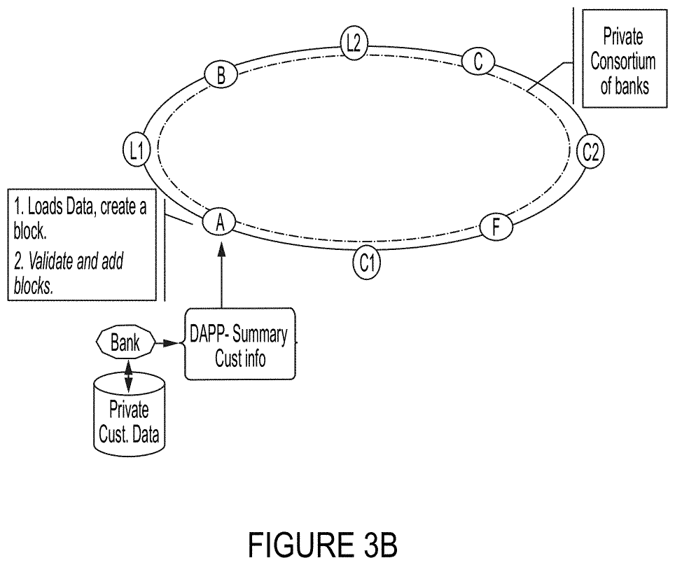

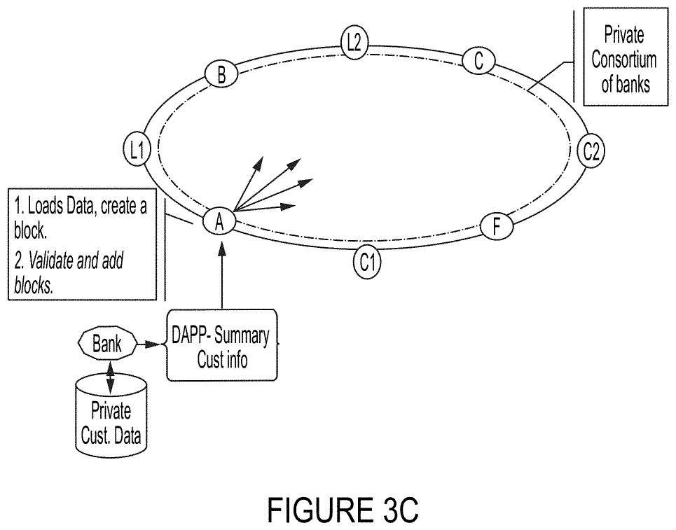

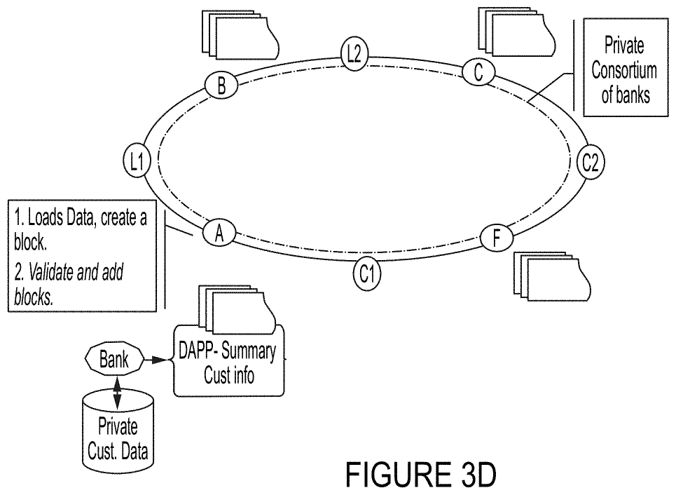

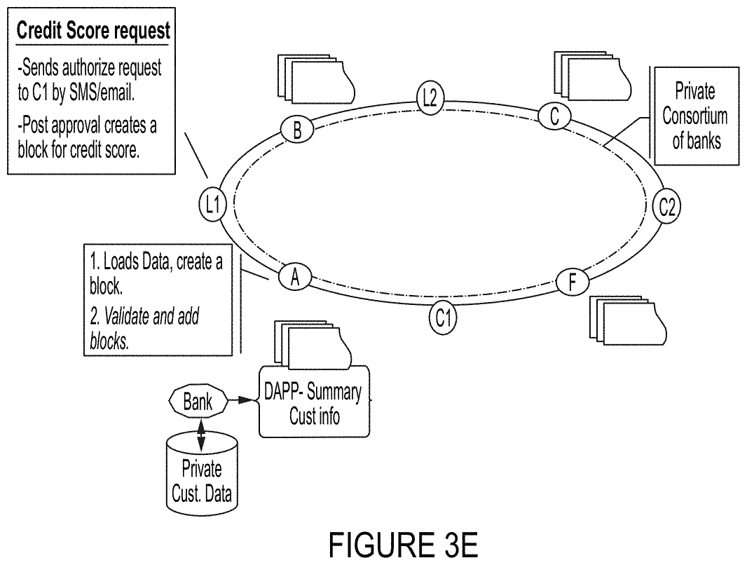

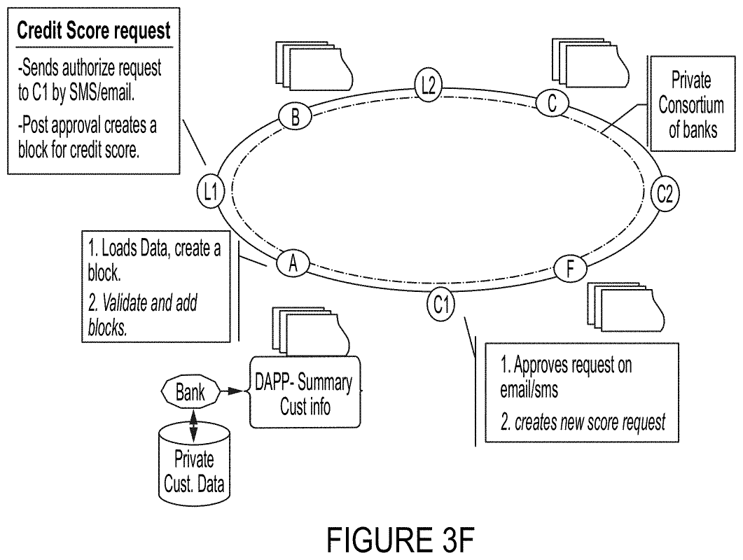

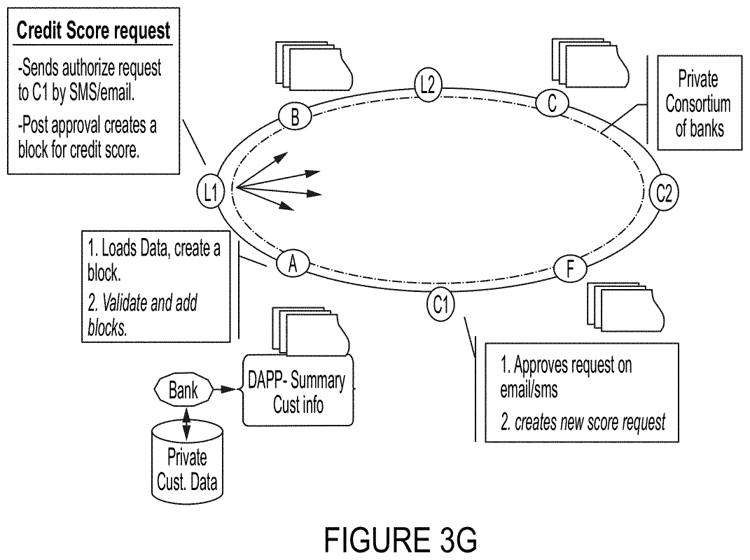

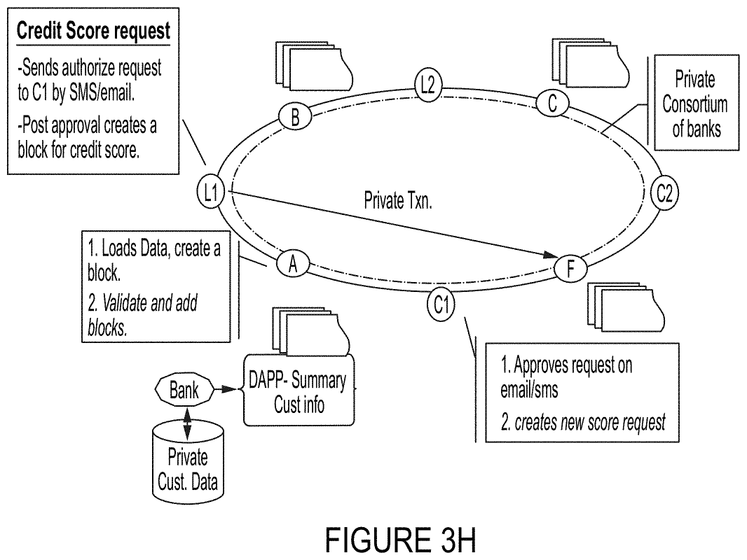

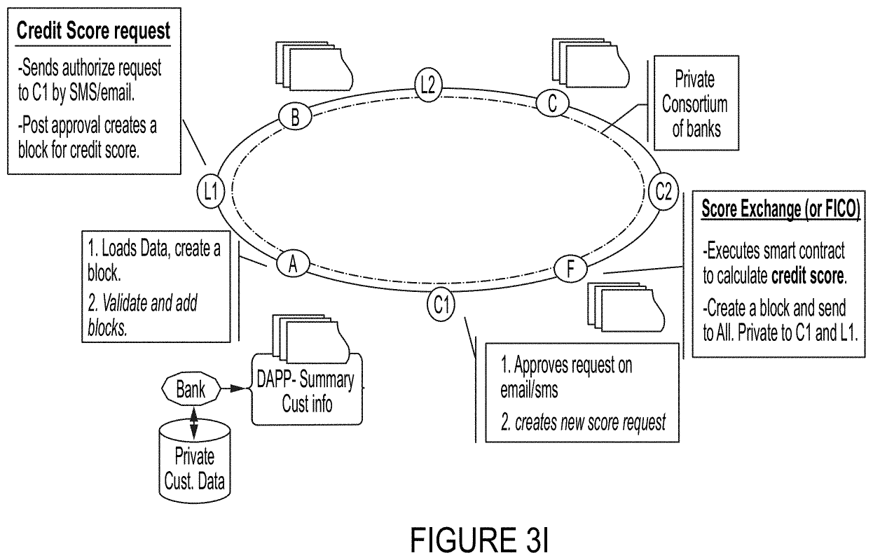

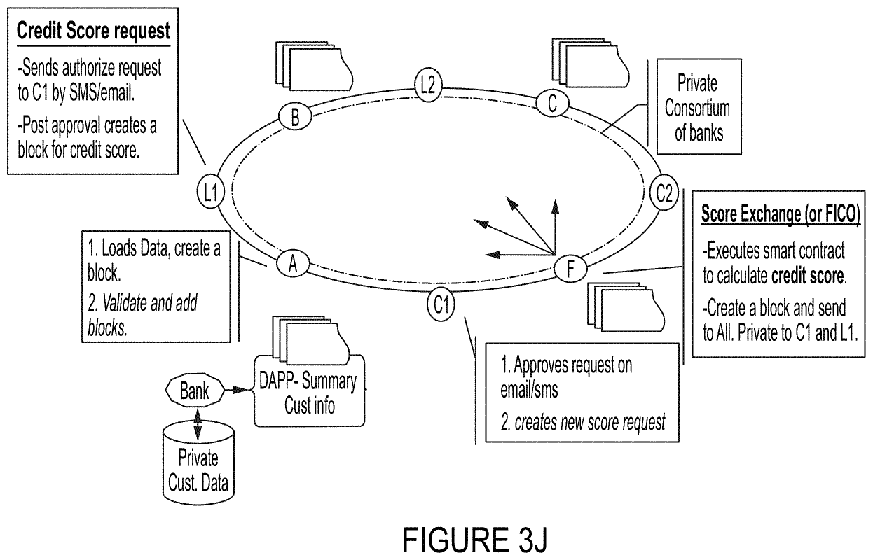

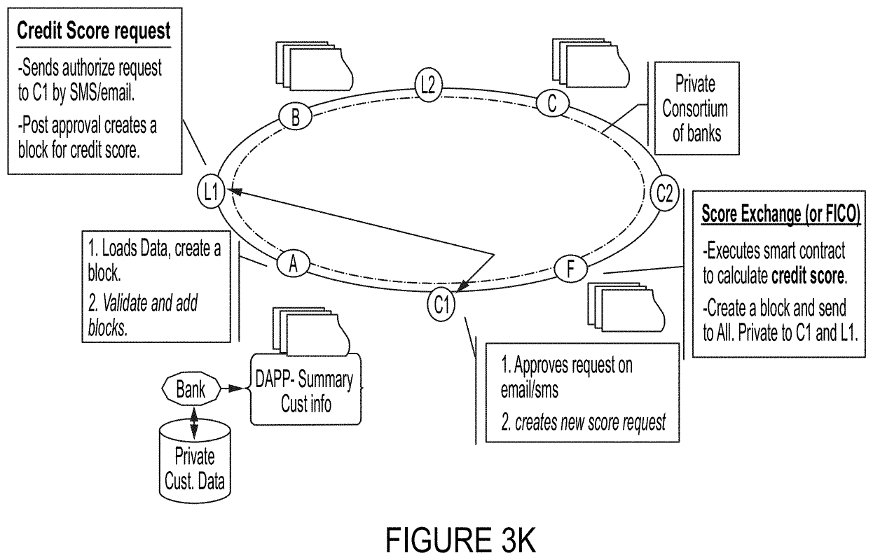

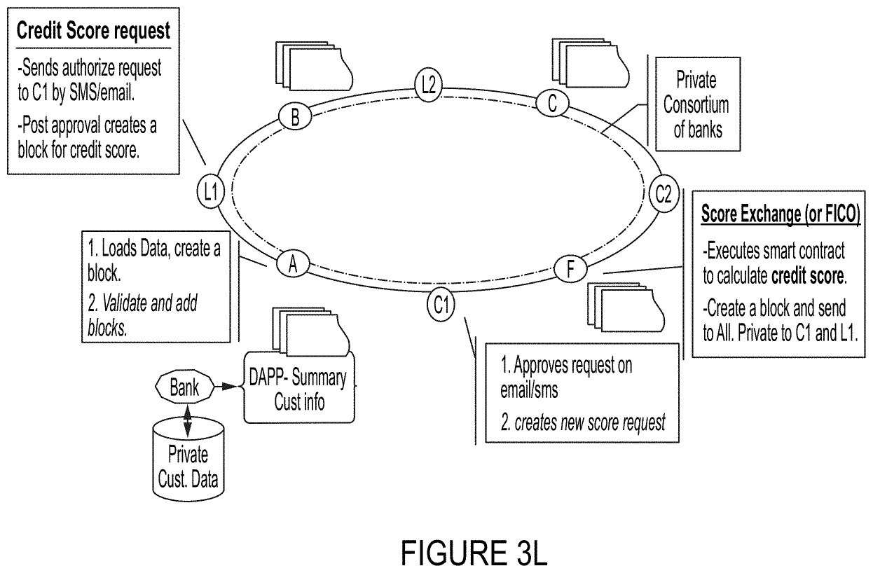

Referring to FIG. 3A, a method for decentralized and distributed-ledger based global credit scoring is disclosed according to one embodiment. In FIG. 3, a customer's transaction is committed to the distributed ledger. For example, a bank may submit customer data to a node in the distributed ledger network, and the node may create a block. All nodes may validate the block, and may add the block to the distributed ledger.

In one embodiment, appropriate privacy measures may be provided.

An illustrative implementation of the process of FIG. 3A is depicted in FIGS. 3B-3L.

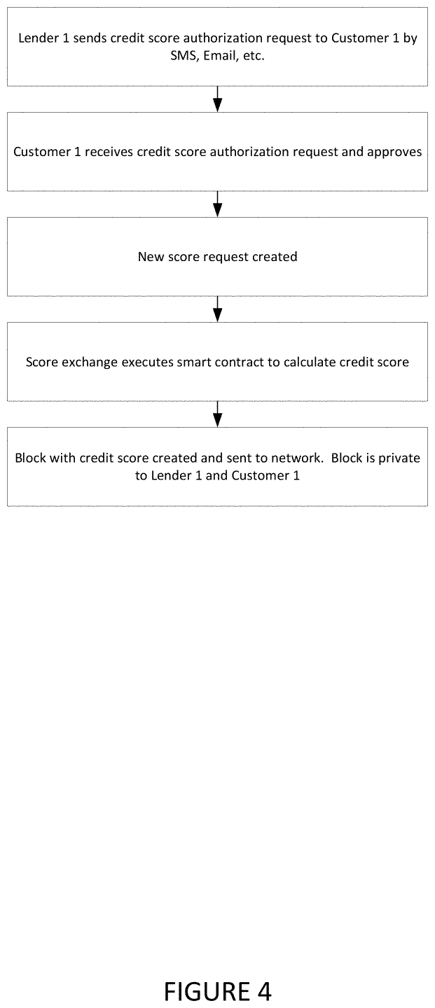

Referring to FIG. 4, a method for decentralized and distributed-ledger based global credit scoring is disclosed according to one embodiment. In FIG. 4, an entity (e.g., Lender 1) is conducting a credit score check on Customer 1.

In one embodiment, Lender 1 may submit a credit score authorization request to Customer 1 via email (e.g., registered email, SMS, etc.), and customer 1 may approve the credit score request. A new score request may then be created by, for example, Lender 1, and this may be published to the distributed ledger. The score exchange may then execute a smart contract to calculate the credit score.

Once the credit score is calculated, a block with the credit score may be sent to the network. The block may be private to Lender 1 and Customer 1.

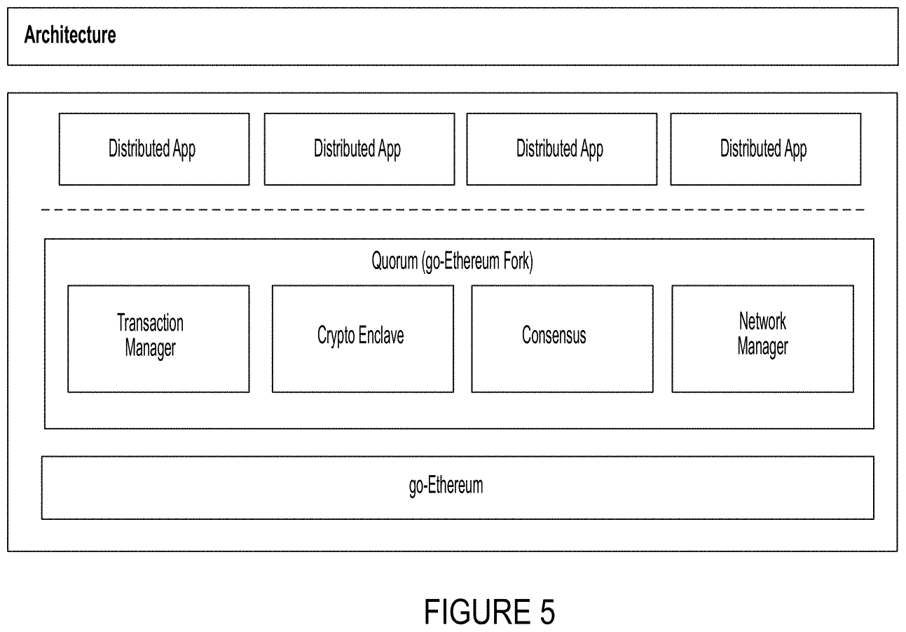

Referring to FIG. 5, an exemplary architecture is provided according to one embodiment.

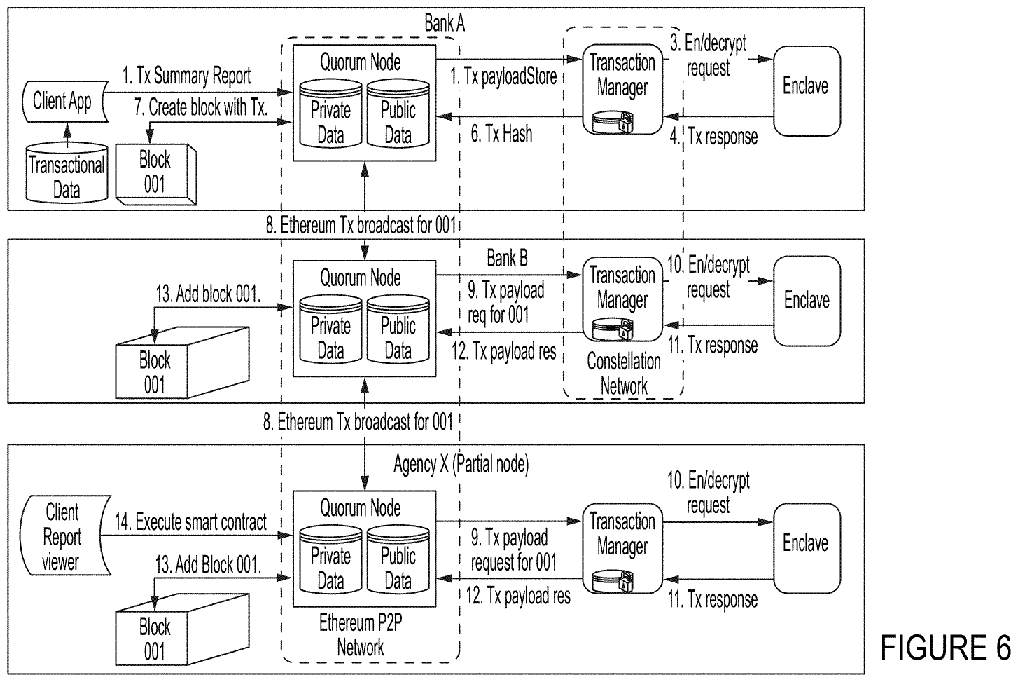

Referring to FIG. 6, an exemplary transaction use case is provided according to one embodiment. Highlights are below:

In step 1, a new transmission may be initiated with the customer's financial summary.

In step 2, the transaction manager may execute a lookup in the privacy dataset to validate the origin and destination nodes.

In step 8, the broadcast message reaches all nodes.

In step 9, the nodes recognized a V value of 37 or 38 if the message is a private message.

In step 13, a block is added to the chain.

In step 14, the smart contract gets the report and calls a report viewer.

The details on the other steps are provided in the figure.

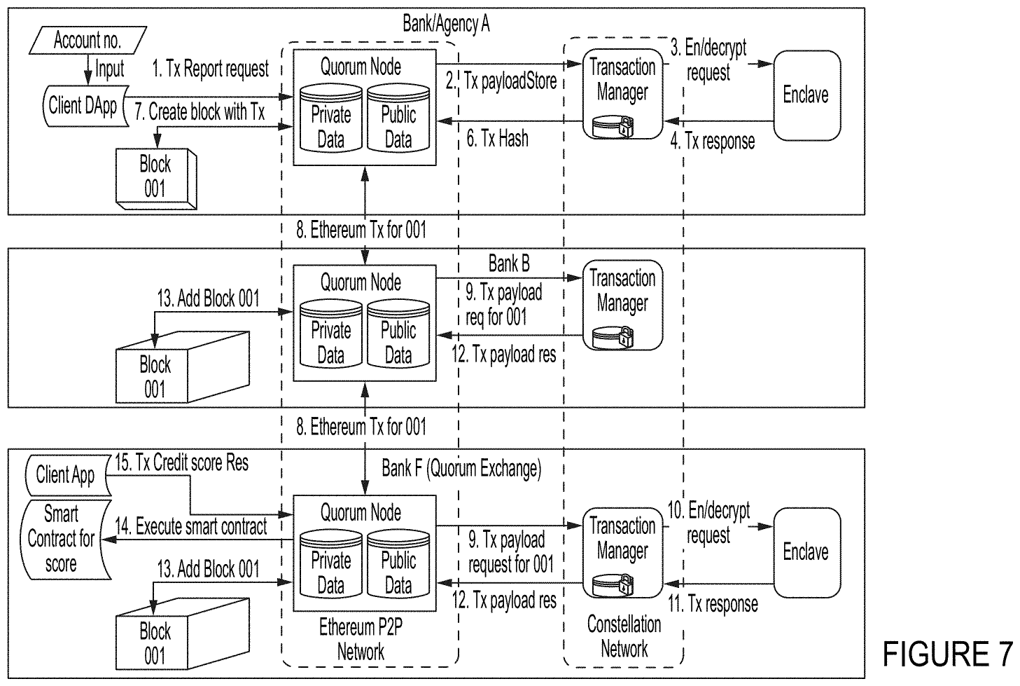

Referring to FIG. 7, an exemplary transaction use case is provided according to one embodiment. Highlights are below:

In step 1, a request to get a credit score for customer 1 is received.

In step 13, a block is added to the chain for the credit score request from client Cl and bank A.

In step 14, a smart contract is executed to calculate the credit score.

In step 15, the smart contract returns the score report to the distribute app to create a new private transmission for the requestor bank and the customer. It then creates an encrypted message, adds a block, and broadcasts.

Step 16 is the beginning of a new private transmission.

The details on the other steps are provided in the figure.

Embodiments may provide at least some of the following:

(1) the system may bypass centralized and legacy system and favors a decentralized and highly encrypted ledger system;

(2) it may remove the dependency on third party credit bureaus;

(3) people data is safe by using blockchain and is be available anytime;

(4) one knowledge base ensures single credit score calculation;

(5) eliminates unauthorized modification of personal data, result peace of mind;

(6) simplified search for all networked and authorized agencies;

(7) disputes can be handled between bank and customer—no third-party involvement is required; and

(8) reporting is available without a mediator;

In addition, embodiments may provide the following advantages for international banking.

(1) banks across the world can join the chain and calculate their scores on local scoring parameters;

(2) a global score is generated by smart contract;

(3) the system will help FBAR and FATCA;

(4) networked banks may receive more customers who travel frequently, as they will have their score in other country;

(5) finance a car or taking mortgage may be easier for relocated people.

In one embodiment, the credit exchange (like FICO) may charge a fee for score from direct customers.

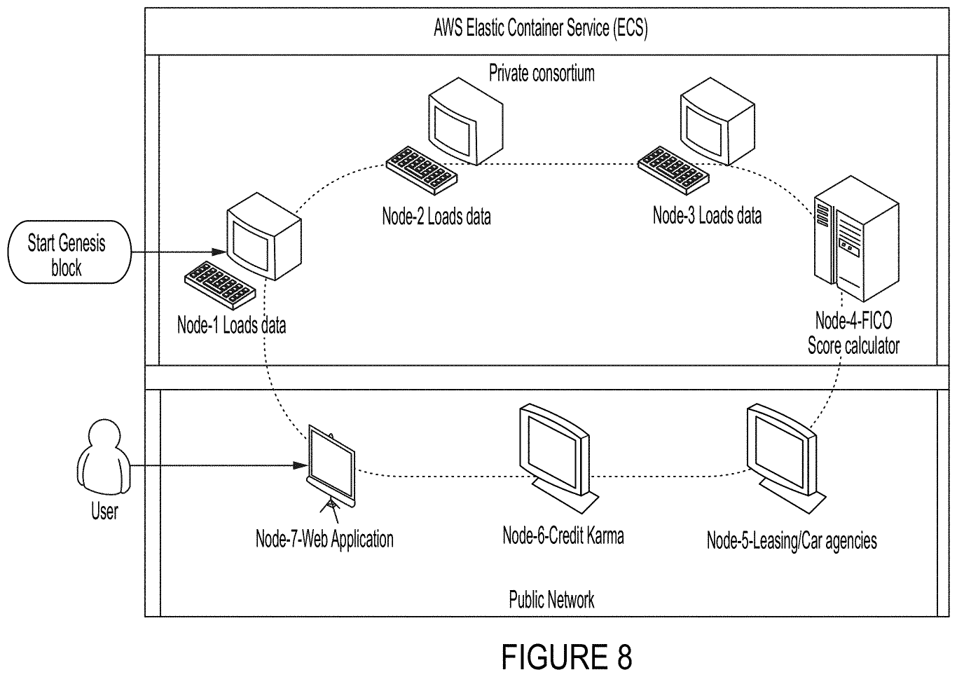

Referring to FIG. 8, an exemplary illustration of an implementation is provided according to one embodiment. In the example, AWS ECS (Container service) hosts 7 nodes connected by peer-to-peer. Node 1, 2, 3 are banks and share private contracts for loading data on blockchain. Node 4 is credit exchange (FICO) which is private and calculates the score. It also reacts to a request from a public node after authorizing as a registered node.

Nodes 5 and 6 are financial agencies, which cannot load any data, but they can request as read only.

Node 7 is a web application that interacts with the node as read only mode and gives access to general users to see request and raise dispute. This can be a bank service as well.

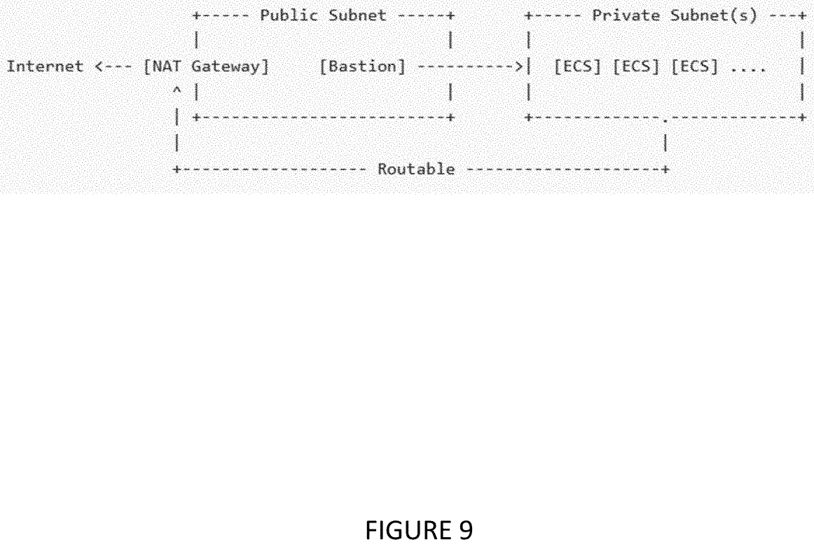

FIG. 9 depicts a dashboard with AWS privacy architecture according to one embodiment.

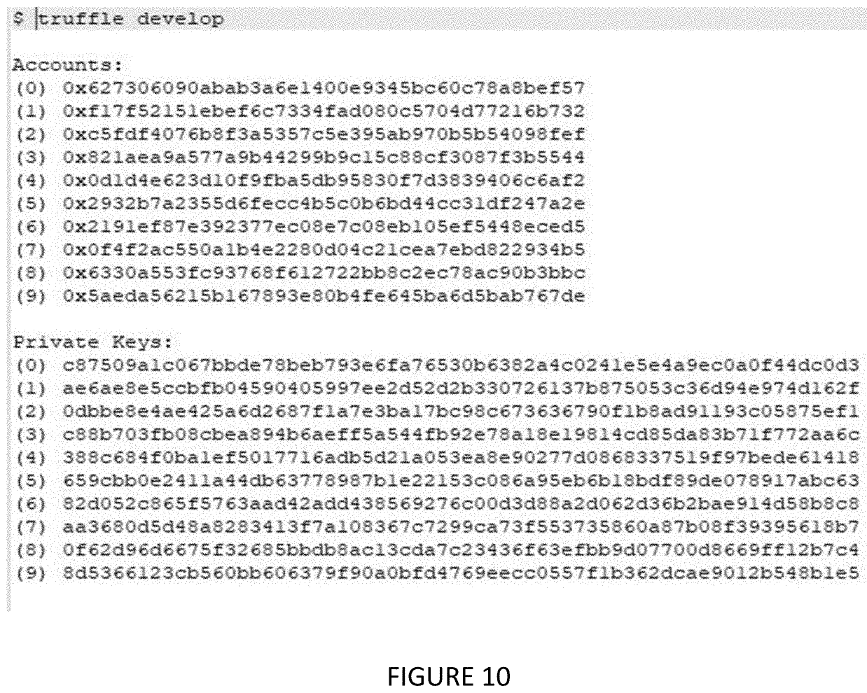

FIG. 10 depicts examples of accounts and private keys according to one embodiment.

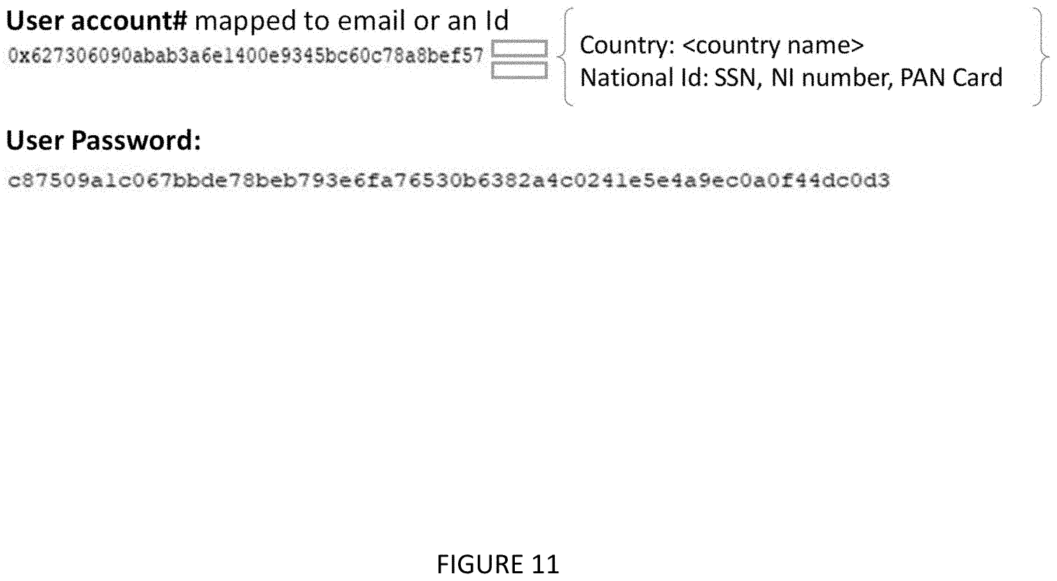

FIG. 11 depicts an exemplary user account number and password according to one embodiment.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes disclosed herein.

The processing machine used to implement embodiments may utilize a suitable operating system. Thus, embodiments may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method. Rather, any number of different programming languages may be utilized as is necessary and/or desired.

Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while embodiments present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for decentralized and distributed-ledger based global credit scoring, comprising:
receiving, at a bank node in a distributed ledger network comprising a plurality of nodes, the bank node comprising a computer processor, customer data and transaction data for a customer transaction;
creating, by the bank node, a block comprising the customer data and the transaction data; and
submitting, by the bank node, the block to the distributed ledger network;
wherein the plurality of nodes in the distributed ledger network validate the block and write the block to the distributed ledger.
